(19) United States
(12) Patent Application Publication
(10) Pub. No.: US 2008/0289660 A1
(43) Pub. Date: Nov. 27, 2008

(54) Semiconductor Manufacture Employing Isopropanol Drying

(75) Inventors: Thomas Burkley Hackett, Colorado Springs, CO (US); Forrest Eli Hulbert, Macungie, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 11/752,606

(22) Filed: May 23, 2007

(51) Int. Cl. B08B 3/10

(52) U.S. Cl. 134/30

(57) ABSTRACT

This invention is directed to an improvement in a wet chemical process for producing electronic precursors. In such process a silicon surface is treated with a wet chemical and the wet chemical subsequently removed therefrom by contact with a drying vapor. In this case, the improvement in the process comprises:
employing a drying vapor comprised of isopropanol; and,
maintaining the isopropanol employed in said drying vapor at a temperature below about 80° F. prior to forming said drying vapor.

Preferably the isopropanol is maintained free from exposure to light from the time of manufacture to the time of use.

### BACKGROUND OF THE INVENTION

Electronic component precursors such as integrated circuits on semiconductor wafers are produced by a variety of methods including wet processing. In wet processing methods, the wafers are exposed to a variety of wet chemicals and processing fluids in order to clean the wafers, remove photoresists, etch patterns into the wafers, and the like.

The removal of water associated with the various rinse steps in wet chemical processing has been a major objective. Removal of particles present even in highly purified water and the elimination of water spotting are necessary. Water spots can cause killer defects, high leakage currents, critical-dimension variations, and film adhesion problems, all of which also may contribute to yield loss.

Several drying technologies have been proposed which include spin/rinse and vapor drying. One method of vapor drying of semiconductor substrates employs isopropyl alcohol (IPA). In a typical IPA vapor dryer, semiconductor substrates, wet with de-ionized water, are introduced into a quartz tank containing a cloud of vaporized IPA. A resistive heater, mounted to the bottom of the quartz tank, is used to heat a reservoir of liquefied IPA and generate an IPA vapor cloud. IPA condenses out on the relatively lower temperature substrate and mixes with the de-ionized water on the semiconductor substrate. Because the resulting mixture comprised of isopropanol and water has a reduced surface tension, the mixture can flow off the semiconductor substrate, and thereby remove the de-ionized water from the semiconductor substrate.

The following references are illustrative of wet chemical processing associated with the production of electronic precursors such as semiconductor wafers including the drying of the electronic precursors: U.S. Pat. No. 4,984,597; U.S. Pat. No. 5,571,337; U.S. Pat. No. 6,496,099; U.S. Pat. No. 6,830,628; and U.S. Pat. No. 7,000,621. The present invention overcomes problems with higher defectivity on semiconductor substrates processed or “dried” with isopropanol, as will be set forth below.

### BRIEF SUMMARY OF THE INVENTION

The present invention generally relates to an improvement in a wet chemical process for producing electronic precursors wherein a silicon surface is treated with a wet chemical and the wet chemical subsequently removed therefrom by contact with a drying vapor. The improvement in the process comprises:

employing a drying vapor comprised of isopropanol; and,

maintaining the isopropanol employed in said drying vapor at a temperature of 80° F. and below from the time of manufacture to time of formation of said drying vapor.

Some of the advantages which may be available through the use of this drying process includes the following:

an ability to reduce contamination of the silicon surface; and,

an ability to employ a favorable drying vapor for removing wet chemicals from a process.

### DETAILED DESCRIPTION OF THE INVENTION

There are many associated wet chemical processes for the manufacture of electronic devices on semiconductor substrates such as silicon wafers. In these processes, the wafer initially is cleaned to remove contaminants and subsequently exposed to a variety of chemicals depending upon the nature of the process. For example, wafers often are exposed to an HF clean to remove contaminants and the HF subsequently removed by rinsing the surface with water. Prior to further treatment, the residual wet chemicals, including water, are removed by the use of a drying process.

Another type of wafer cleaning process is described as chemical/mechanical polishing wherein a polishing agent is dispersed in an aqueous medium. After polishing the surface of the wafer, the surface is rinsed with water and the water removed via a drying step.

One of the conventional ways of removing wet chemicals, and particularly water, present in the rinse fluids, from the silicon wafer is to subject it to an isopropanol drying step. In this step, the wet surface is contacted with a drying vapor comprised of isopropanol. Isopropanol is preferred, because of its miscibility with water and because it forms a low boiling azeotrope. Other features of isopropanol as a drying agent include; its low surface tension, its hydrophilic characteristics and hydrophobic characteristics.

In the drying process, isopropanol is drawn from a storage unit and typically heated to a vapor state. In some vapor dryers, a non-condensable gas, e.g., nitrogen can be used to carry the isopropanol to the silicon wafer surface. The hot isopropanol vapor is contacted with the wet chemical on the surface of the relatively cooler wafer, e.g., water and on contact with water, the isopropanol condenses and mixes with the water. Since the surface tension of the isopropanol-water mixture is significantly reduced over than of pure water, the isopropanol-water mixture readily flows from the surface of the wafer, thus removing the water from the silicon wafer. The hot isopropanol vapors continue to condense onto the silicon wafer surface and effectively remove all traces of water.

One problem that has occurred in wet chemical processing of silicon wafers is that of surface oxidation causing killer defects. While not intending to be bound by theory, it is believed that the contamination of the silicon wafer might have been caused by trace levels of peroxides and decomposition products present in or formed during the drying of the surface of the silicon wafer by the drying vapor. And further not intending to be bound by theory, it was conjectured that the peroxides and decomposition products, which may have caused the defects in the silicon wafers, were attributable to the isopropanol employed in the drying vapor.

To determine if the presence of byproduct peroxides could be a contributing cause of such defects in silicon wafers, a study was carried out wherein the wafers were contacted with aqueous mixtures incorporating varying amounts of trace levels of peroxides. From this study, it was concluded that the presence of peroxides might be a culprit in the wet chemical process, particularly when the peroxides were contained in isopropanol and were in contact with water on the silicon substrate.

The flow scheme below shows a general path for isopropanol from the point of manufacture to its end use in the drying of silicon wafers.

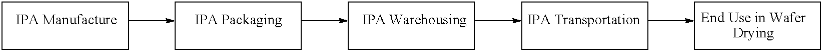

In the first stage, isopropyl alcohol is manufactured, typically by the reaction of propylene and sulfuric acid to form propyl sulfate, which is then reacted with water to form crude isopropyl alcohol. The crude alcohol is refined in distillation columns, not only to purify the IPA, but also to concentrate the alcohol above its azeotrope concentration with water. In the second step, IPA is filtered, shipped and packaged in its final container to meet the customer's requirement. In the third and fourth steps, the IPA is warehoused until needed by the end user and transported to the customer. In the fifth step, the customer uses the IPA in wafer drying.

In evaluation of the above process for the manufacture and distribution of isopropanol for use in the formation of drying vapors for semiconductor manufacture, it was observed that there was an opportunity for isopropanol to be exposed to elevated temperatures of ambient environments. For example, isopropanol shipped and then subsequently warehoused in the southern portion of the United States, e.g., Texas and Arizona, may experience temperatures in excess of 100° F. and sometimes in excess of 110° F. It was theorized by the present inventors, that isopropanol shipped and/or stored at such temperatures had a propensity to decompose to some extent to form peroxides.

To overcome any unknown problem of silicon wafer contamination caused by isopropanol through possible peroxide and byproduct formation, it was proposed by the inventors herein that the isopropanol employed in the drying vapor and used for removal of wet chemicals in silicon wafer processing be maintained from the time of manufacture, e.g. during shipping, to the time of use, e.g., during storage, at a temperature of 80° F. and below and preferably at a temperature of 72° F. and below. Generally, the preferred temperatures for shipment and storage of isopropanol for use as a drying vapor in the fabrication of silicon wafers range from 55 to 80° F. Further, it is proposed that the isopropanol be limited in exposure to light from the time of manufacture to the time of use.

Based upon the above belief, it has been proposed by the inventors that isopropanol for use as a component of a drying vapor for electronic precursors including silicon wafer processing be shipped in transport vessels such as tank trucks and drums incorporating refrigeration capable of maintaining temperature conditions of 80° F. and below, as well as storing the isopropanol in warehouses incorporating refrigeration, such as mechanical air conditioning, cooling towers using evaporative cooling and any other know method of maintaining set temperatures in an ambient environment where temperatures can at least for periods of time exceed that set temperature.

Silicon wafer processing has been carried out using isopropanol shipped and stored under conditions during transport in transport vessels, such as tank trucks and drums during warehousing employing refrigeration, wherein the temperature of the isopropanol has not exceeded 80° F. from the time of manufacture to the time of its use as a drying vapor.

It has been found that such silicon wafers have fewer defects attributable to the drying process than silicon wafers produced with isopropanol shipped and stored in the warm environments under conventional conditions. Thus, it has been concluded that maintaining isopropanol under a maximum temperature may result in fewer defects in silicon wafers processed using wet chemicals and a drying vapor comprised of isopropanol.

1. A wet chemical process for producing electronic devices comprising:
treating a semiconductor substrate with a wet chemical;
obtaining liquid isopropanol;
forming a drying vapor comprising isopropanol from the liquid isopropanol;
removing the wet chemical from the semiconductor substrate by contact with the drying vapor;
and maintaining the liquid isopropanol at a temperature in the range of 80° F. and below for the duration of time between obtaining the liquid isopropanol and forming said drying vapor therefrom.

2. The process of claim 1 further comprising maintaining the liquid isopropanol in an environment substantially free from exposure to light prior to forming said drying vapor therefrom.

3. The process of claim 1 wherein the temperature of the liquid isopropanol is maintained at a temperature in the range of 72° F. and below prior to forming said drying vapor therefrom.

4. A wet chemical process for processing semiconductor substrates having a surface, the process comprising:
treating the surface of the substrate with a wet chemical; and
removing the wet chemical from the surface of the substrate by contact with a drying vapor comprising isopropanol, wherein the drying vapor is formed from liquid isopropanol, and
wherein the liquid isopropanol has been shipped in transport using refrigeration such that the liquid isopropanol is maintained at a temperature in the range of 80° F. and below during the transport.

5. The process of claim 4 wherein the liquid isopropanol shipped in said transport is stored in a warehouse prior to use and the warehouse is equipped with sufficient air conditioning to maintain the liquid isopropanol at a temperature in the range of 80° F. and below.

6. The process of claim 5 wherein the liquid isopropanol is maintained at a temperature in the range of 72° F. and below.

7. The process of claim 5 wherein, in the wet chemical process, the surface of the substrate is rinsed with water prior to contact with said drying vapor.

8. A wet chemical process for producing electronic devices manufactured from semiconductor substrates using comprising:
treating a surface of the substrate with a wet chemical;
rinsing the wet chemical from the surface with water;
removing the water from the surface by contact with a drying vapor comprising isopropanol, wherein the drying vapor is formed from liquid isopropanol; and
employing liquid isopropanol that has been maintained at a temperature in the range of from 55° F. to 80° F. from the point of manufacture of the liquid isopropanol until formation of drying vapor therefrom.

9. The method of claim 8 wherein the liquid isopropanol has been shipped, stored, or both following manufacture, and wherein the temperature of the ambient environment through which the liquid isopropanol has been shipped, in which the liquid isopropanol has been stored, or both may, at times, exceed 100° F.

10. The process of claim 1, wherein the liquid isopropanol is substantially free of peroxide.

11. A wet chemical process for producing electronic devices comprising:
treating a semiconductor substrate with a wet chemical;
forming a drying vapor comprising isopropanol from liquid isopropanol, wherein the liquid isopropanol is substantially free from peroxide; and
removing the wet chemical from the semiconductor substrate by contact with the drying vapor.

12. The process of claim 11, further comprising preventing the formation of peroxide from the liquid isopropanol.
